(19) United States
(12) Patent Application Publication
(10) Pub. No.: US 2007/0160374 A1
(43) Pub. Date: Jul. 12, 2007

(54) Optical transmitter and method for controlling optical transmitter

(75) Inventors: Kensuke Matsui, Ashigarakami-gun (JP); Tetsuya Kiyonaga, Kawasaki (JP); Takahiro Fujimoto, Kawasaki (JP); Hiroshi Yamada, Yokohama (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/403,610

(22) Filed: Apr. 13, 2006

(30) Foreign Application Priority Data
Dec. 20, 2005 (JP) 2005-366471

(51) Int. Cl. H04B 10/04

(52) U.S. Cl. 398/195; 398/182

(57) ABSTRACT

An optical transmitter includes a laser diode drive circuit for driving a laser diode in accordance with a laser diode current that superimposes a pilot signal on a “0” logic level and a “1” logic level of a transmission signal, the pilot signal having a low-frequency compared with the transmission signal, so as to become an opposite phase each other, a monitor circuit for monitoring an optical output of the laser diode, a filter circuit for extracting a low-frequency component of the pilot signal from an output of the monitor circuit, a phase compare circuit for comparing a phase of the low-frequency component of the pilot signal extracted by the filter circuit with a phase of the pilot signal, and a deterioration judgment circuit for judging whether or not the laser diode deteriorates in accordance with a comparison result of the phase compare circuit.

### BACKGROUND OF THE INVENTION

1. Field of the Invention

The present invention relates to optical transmitters, and more particularly, to an optical transmitter that performs deterioration detection of the optical transmitter using a laser diode (LD) and that controls an extinct ratio in accordance with a result of the deterioration detection.

2. Description of the Related Art

Optical transmitters using an LD as a light source are available for an optical transmission system capable of long-distance transmission. In order to make an optical transmission distance longer, optical transmitters control optical transmission power to a constant value. In addition, optical transmitters control an extinct ratio, which is a level ratio of a logical level “1” to a logical level “0” of an optical transmission signal, to be within a predetermined range.

FIG. 12 is a diagram for explaining direct modulation of an LD. A peripheral circuit of an LD 101 is shown on the right side of FIG. 12, and an LD drive circuit including an amplifier (AMP) 102 is shown on the left side of FIG. 12. A transmission signal (2) is modulated in accordance with a modulation current Ip controlled based on an Ip control signal (4), and is applied to the LD 101 biased at an LD threshold current Ith or more in accordance with a bias current Ib controlled based on an Ib control signal (5). The LD threshold current Ith is a minimum current at which the LD 101 can oscillate.

FIGS. 13A to 13C are diagrams for explaining an optical output in which a transmission signal is modulated. FIG. 13A shows a transmission signal. FIG. 13B shows an optical output signal in which a continuous wave (CW) of an LD that oscillates by being biased in accordance with a bias current Ib is modulated in accordance with a modulation current Ip, which is used for modulating the transmission signal. The optical output signal is generally represented as a waveform in which a continuous wave CW of the LD that uniquely oscillates is omitted, as shown in FIG. 13C. In other words, the LD oscillates and generates the continuous wave CW by being biased at the LD threshold current Ith or more, the amplitude value of the continuous wave CW is determined in accordance with the received modulation current Ip, and the LD outputs an optical signal from which the transmission signal can be identified in accordance with the level of the continuous wave CW.

FIG. 14 is a diagram for explaining LD conversion efficiency. An LD conversion efficiency curve (103) represents the relationship between an LD current and optical output power. An LD starts stimulated emission when the LD current exceeds a critical level. The critical level is represented as an LD threshold current Ith in FIG. 14. Generally, a bias current Ib and a modulation current Ip are set such that the LD current exceeds the LD threshold current Ith. Reference numeral (104) denotes an LD current when a transmission signal has a random pattern. Reference numeral (105) denotes an optical output of the LD that oscillates when the LD current (104) is applied. An operation point of the LD current is determined in accordance with the bias current Ib used for bias at the LD threshold current Ith or more, and a motion range of the LD current is determined in accordance with the modulation current Ip. An amplitude of the optical output is determined in accordance with the gradient of the LD conversion efficiency curve (103). Thus, the optical output power is controlled based on the bias current Ib and the modulation current Ip, and the extinct ratio is controlled based on the modulation current Ip.

Direct modulation of the LD is described next with reference to FIGS. 12 to 14. The transmission signal (2) is modulated in accordance with the modulation current Ip in the AMP 102, and applied to the LD 101 biased in accordance with the bias current Ib set to the LD threshold current Ith or more. Thus, the LD current (104) to be applied to the LD 101 functions as a signal having amplitude of the modulation current Ip centered on the operation point biased in an LD current range of the LD conversion efficiency curve (103) in which the LD is capable of oscillating, and the optical output (105) is gained due to a characteristic of the LD conversion efficiency curve (103). Accordingly, the extinct ratio is affected by the gradient of the LD conversion efficiency curve (103) and the size of the modulation current Ip.

FIG. 15 is a diagram for explaining control for the optical transmitter. A photodiode (PD) 111 monitors an optical output of the LD 101. An LD drive circuit 112 is the circuit shown in FIG. 12. A control circuit 113 is a circuit that controls the LD drive circuit 112.

FIG. 16 is a diagram for explaining monitoring of an optical output. Reference numeral (106) denotes a PD current of a signal monitored by the PD 111. Part of output light of the optical output (105) is received by the PD 111, and is subjected to photoelectric conversion. Accordingly, the PD current (106) is acquired.

The control circuit 113 receives a monitor current of the PD 111, and controls the LD drive circuit 112 using the Ip control signal (4) and the Ib control signal (5) shown in FIG. 12 such that the optical output of the LD 101 is constant power determined in advance. The control circuit 113 also controls the LD drive circuit 112 using the Ip control signal (4) in order to control the extinct ratio of the LD 101.

FIG. 17 is another diagram for explaining LD conversion efficiency. FIG. 17 shows a case where the modulation current Ip increases from the value shown in FIG. 14. This represents that the extinct ratio increases in accordance with the LD conversion efficiency curve (103). In this case, although not shown in FIG. 17, when the bias current Ib increases, the operation point moves and the optical output power increases.

Since LD conversion efficiency is susceptible to a temperature change and changes with age, the LD threshold current Ith and the gradient of the LD conversion efficiency curve (103) are not constant. Thus, there is a need to perform auto power control (APC) in order to maintain the optical output power constant and to perform auto modulation control (AMC) in order to maintain the extinct ratio within a predetermined range.

A technology, as a control technology for the APC and the AMC, in which in order to control optical output power and an extinct ratio of a laser diode to be constant with respect to long-term deterioration, optical output power of the laser diode before deterioration is detected, the detected value is stored as a reference value, and feedback control is performed for the reference value is disclosed in Japanese Unexamined Patent Application Publication No. 11-135871.

In addition, a technology in which an operation point of a bias current Ib and a motion range of a modulation current Ip of an LD conversion efficiency curve in the process of operation are compared with an operation point of the bias current Ib and a motion range of the modulation current Ip of the LD conversion efficiency curve set in advance and optimal optical output power and extinct ratio can be ensured by changing the bias current Ib and the modulation current Ip is disclosed in U.S. Pat. No. 6,414,974.

LD conversion efficiency differs depending on the type of LD. In addition, even for LDs of the same type, LD conversion efficiency differs depending on the ambient temperature and depending on aged deterioration. Generally, deterioration increases by use in high temperature environment and with age.

FIG. 18 is a diagram for explaining deterioration of an LD. Generally, when an LD deteriorates, the gradient of the LD conversion efficiency curve (103) decreases, as shown by LD conversion efficiency curves (103(1)), (103(2)), and (103(3)).

FIG. 19 is a diagram for explaining LD conversion efficiency when an LD deteriorates. As shown in FIG. 19, when the LD deteriorates and the gradient of the LD conversion efficiency curve (103) significantly decreases, the extinct ratio can be increased by increasing the bias current Ib and the modulation current Ip. However, a larger bias current Ib and a larger modulation current Ip are required as the gradient of the LD conversion efficiency curve (103) decreases. In addition, when the LD deteriorates and the gradient of the LD conversion efficiency curve (103) reaches about zero, it is difficult to increase the extinct ratio even if the bias current Ib and the modulation current Ip increase. However, under the APC and AMC, as long as it is not recognized that the LD conversion efficiency is significantly degraded due to deterioration of the LD, feedback control for increasing the bias current Ib and the modulation current Ip is performed until a limiter for the APC and the AMC operates. Thus, unnecessary control is performed. Generally, in an optical transmitter using an LD, when a monitored LD bias current exceeds an allowable LD bias current set in advance, the optical transmitter issues a warning, and control for the optical transmitter is stopped.

### SUMMARY OF THE INVENTION

Accordingly, it is an object of the present invention to provide an optical transmitter using an LD that is capable of rapidly detecting deterioration of the LD. In addition, it is another object of the present invention to provide an optical transmitter capable of acquiring an optimal extinct ratio using a function to detect the deterioration of the LD and a method for controlling the optical transmitter.

An optical transmitter according to an aspect of the present invention includes an LD drive circuit for driving a laser diode in accordance with a laser diode current that superimposes a pilot signal on a “0” logic level and a “1” logic level of a transmission signal, the pilot signal having a low-frequency compared with the transmission signal, so as to become an opposite phase each other; a monitor circuit for monitoring an optical output of the laser diode; a filter circuit for extracting a low-frequency component of the pilot signal from an output of the monitor circuit; a phase compare circuit for comparing a phase of the low-frequency component of the pilot signal extracted by the filter circuit with a phase of the generated pilot signal; and a deterioration judgment circuit for judging whether or not the laser diode deteriorates in accordance with a comparison result of the phase compare circuit.

Accordingly, an optical transmitter using an LD that is capable of rapidly detecting deterioration of the LD can be provided.

An optical transmitter according to another aspect of the present invention further includes a control circuit for controlling one of or both of optical output power of the laser diode and an extinct ratio of the optical output of the laser diode in accordance with a monitor current output by the monitor circuit. The control circuit maintains control for optical output power of the laser diode and the extinct ratio of the optical output of the laser diode when the deterioration judgment circuit judges the laser diode deteriorating.

Accordingly, an optical transmitter that achieves an optimal extinct ratio using a function to detect deterioration of an LD can be provided.

A method for controlling optical transmitter according to an aspect of the present invention includes the steps of driving a laser diode in accordance with a laser diode current that superimposes a bias current on a modulation current for modulating a transmission signal on which superimposes a pilot signal; extracting a low-frequency component of a pilot signal from an output of the monitor circuit; comparing a phase of the low-frequency component of the pilot signal extracted by the filter circuit with a phase of the generated pilot signal; judging whether or not the laser diode deteriorates in accordance with a comparison result of the phase compare circuit; controlling one of or both of optical output power of the laser diode and an extinct ratio of the optical output of the laser diode in accordance with a monitor current output by the monitor circuit; and maintaining control for optical output power of the laser diode and the extinct ratio of the optical output of the laser diode when it is judged that the laser diode deteriorates.

Accordingly, a method for controlling optical transmitter capable of achieving an optimal extinct ratio using a function to detect deterioration of an LD can be provided.

According to the optical transmitter and the method for controlling optical transmitter, in a state in which LD conversion efficiency deteriorates since an LD provided in the optical transmitter deteriorates due to a temperature increase or deteriorates with age, the deterioration of the LD can be rapidly detected. In addition, an optical transmitter that is capable of controlling a bias current Ib and a modulation current Ip to achieve an optimal extinct ratio in accordance with a result of comparison between phases of pilot signals and a result of detection of amplitude values of the pilot signals can be provided.

### BRIEF DESCRIPTION OF THE DRAWINGS

FIG. 1 is a diagram for explaining an example of the configuration of an optical transmitter according to an embodiment of the present invention;

FIG. 2 is a diagram for explaining direction modulation of an LD according to the embodiment;

FIG. 3 is a diagram for explaining an example of the operation of the optical transmitter according to the embodiment;

FIG. 4 is a diagram for explaining an example of the operation of the optical transmitter according to another embodiment of the present invention;

FIG. 5 is a diagram for explaining an example of the configuration of the optical transmitter according to another embodiment of the present invention;

FIG. 6 is a diagram for explaining an example of the operation of the optical transmitter according to the embodiment;

FIG. 7 is a diagram for explaining an example of the configuration of the optical transmitter according to another embodiment of the present invention;

FIG. 8 includes diagrams for explaining an amplitude compare circuit;

FIG. 9 is a diagram for explaining a deterioration judgement condition;

FIG. 10 is a flowchart of a deterioration judgement and extinct ratio control process;

FIG. 11 is a diagram for explaining an example of the configuration of the optical transmitter according to another embodiment of the present invention;

FIG. 12 is a diagram for explaining direct modulation of an LD;

FIGS. 13A to 13C are diagrams for explaining an optical output in which a transmission signal is modulated;

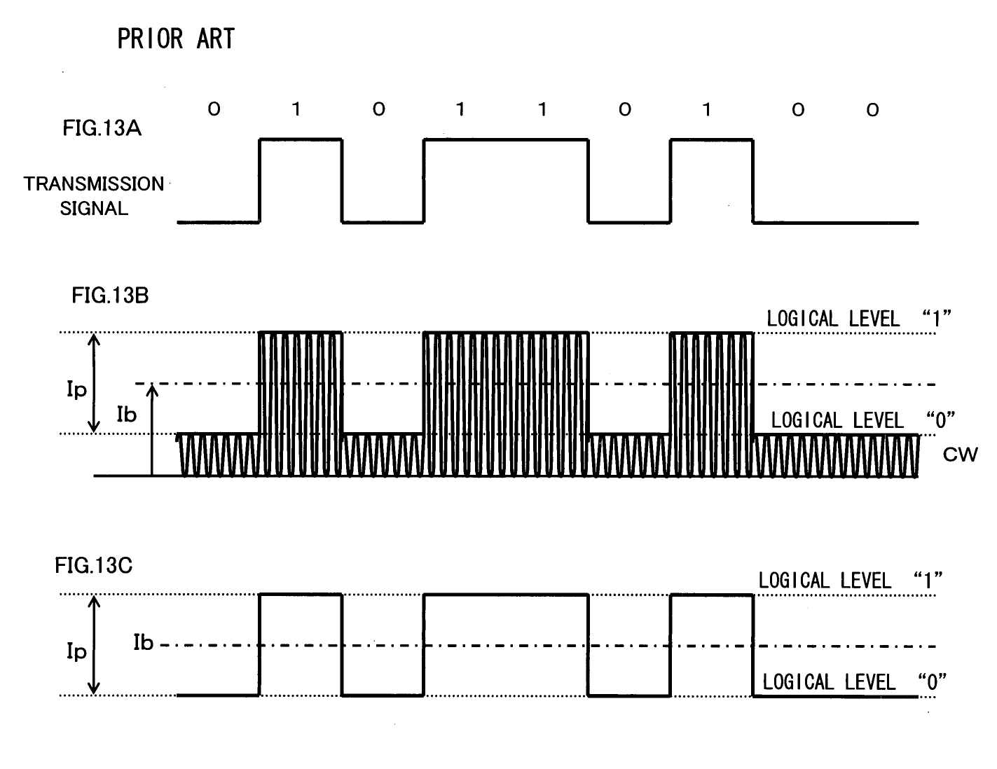

FIG. 14 is a diagram for explaining LD conversion efficiency;

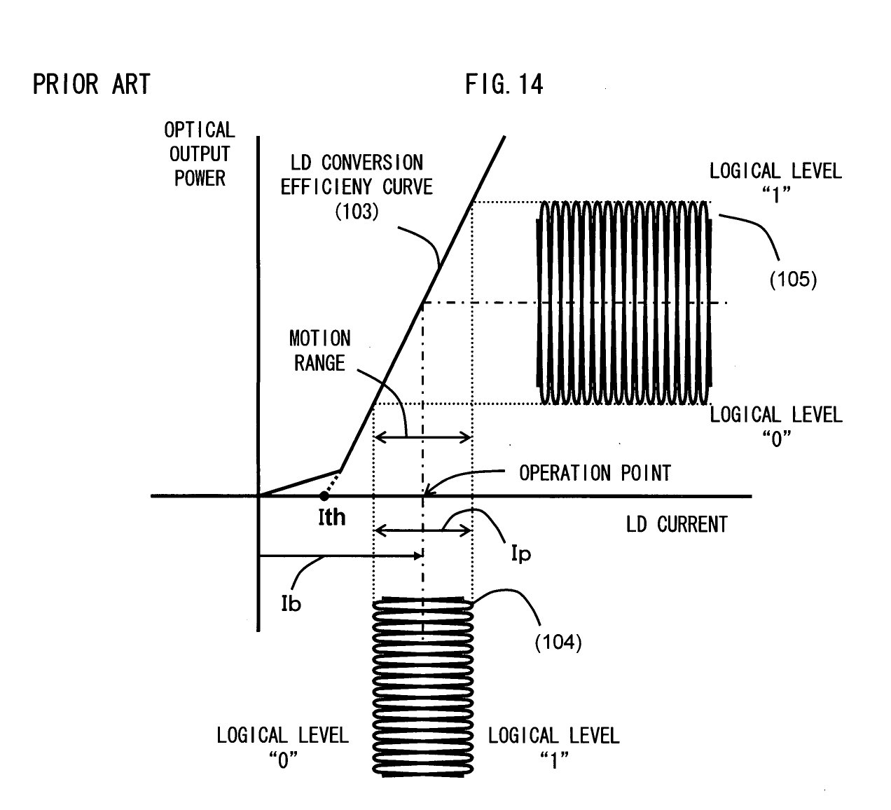

FIG. 15 is a diagram for explaining control for an optical transmitter;

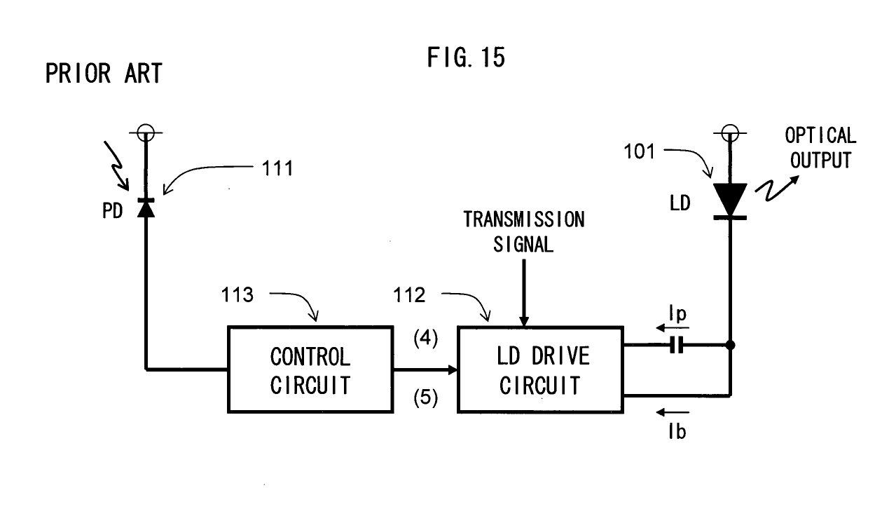

FIG. 16 is a diagram for explaining monitoring of an optical output;

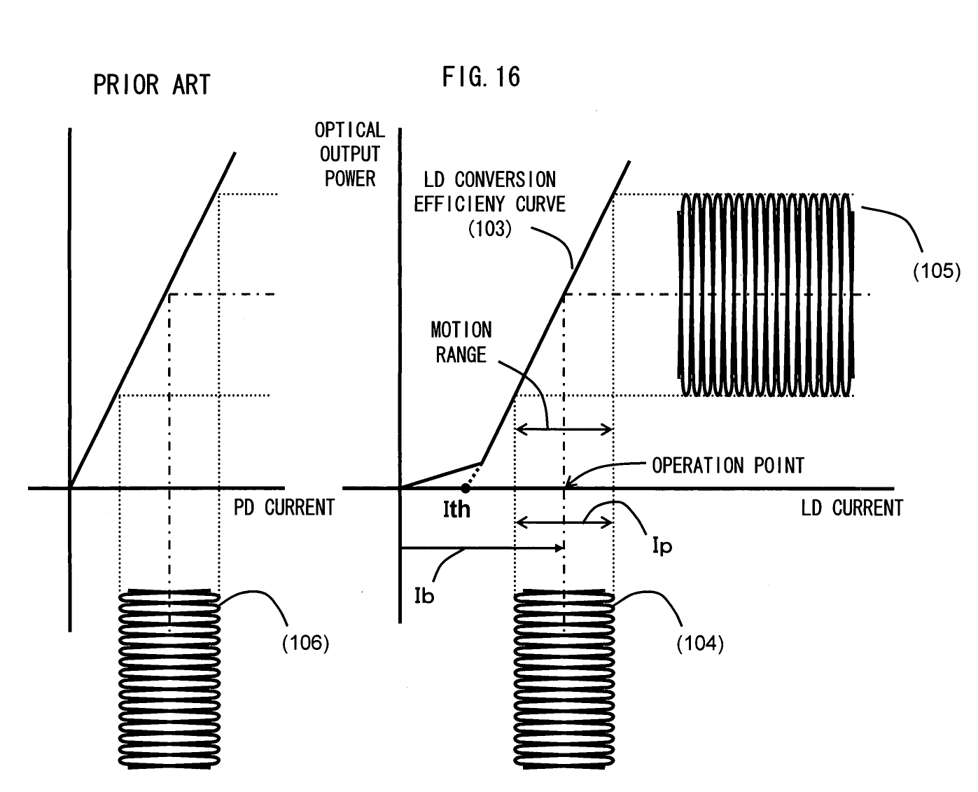

FIG. 17 is another diagram for explaining LD conversion efficiency;

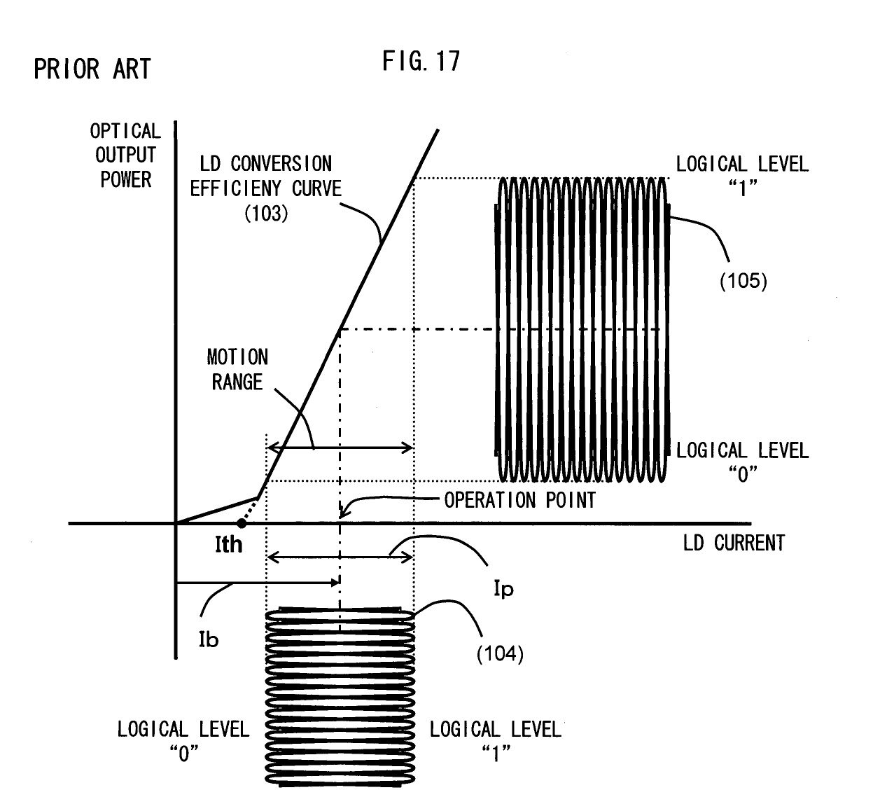

FIG. 18 is a diagram for explaining deterioration of an LD; and

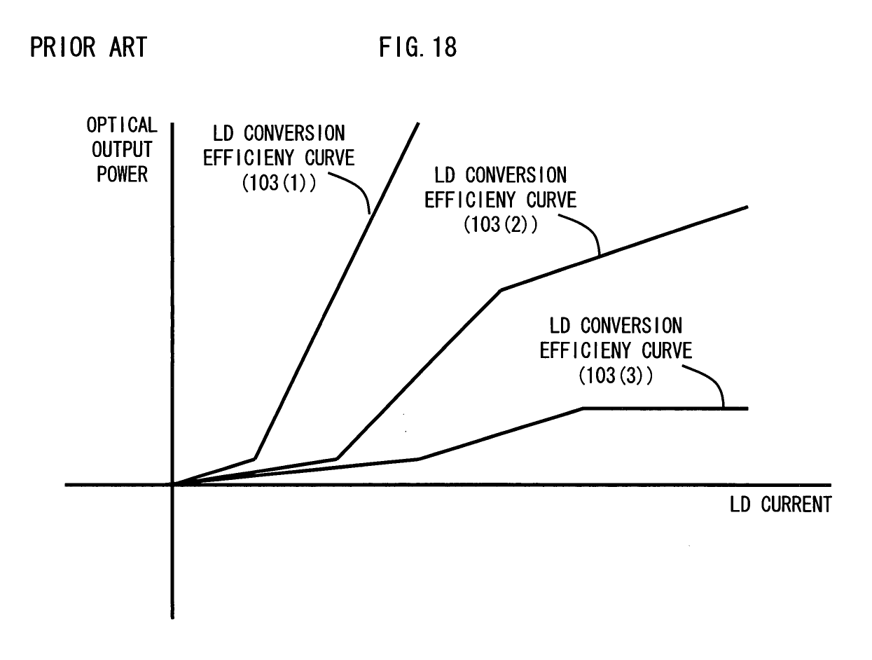

FIG. 19 is a diagram for explaining LD conversion efficiency when the LD deteriorates.

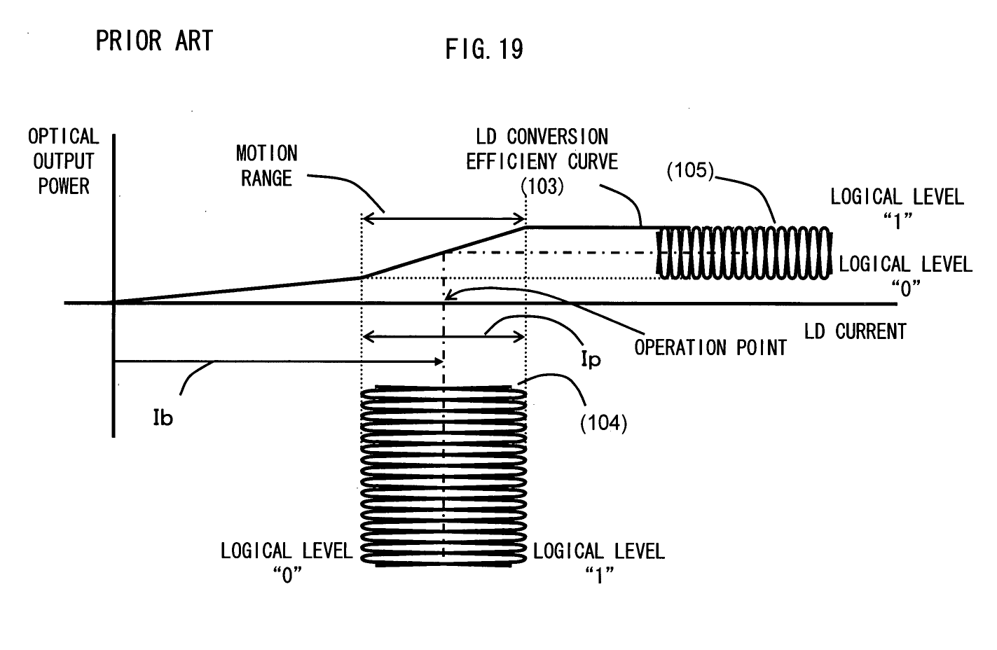

### DESCRIPTION OF THE PREFERRED EMBODIMENTS

Embodiments of the present invention will be described with reference to the drawings. In the descriptions below, the same or similar parts in the drawings are referred to with the same reference numerals.

### First Embodiment

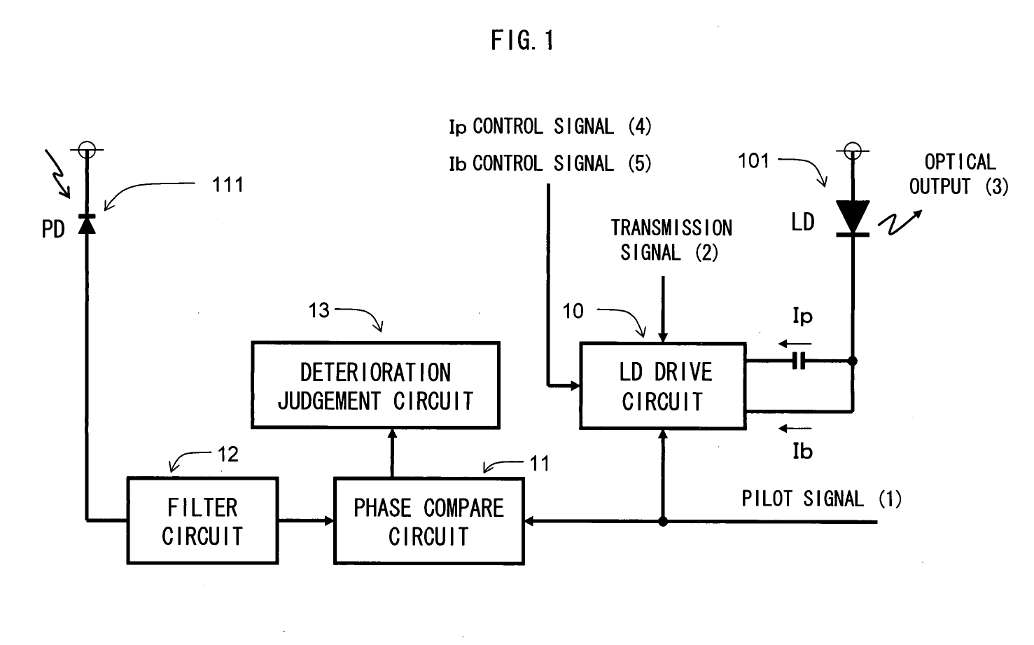

It's explained by using FIGS. 1 to 3.

FIG. 1 is a diagram for explaining an example of the configuration of an optical transmitter according to an embodiment of the present invention. Reference numeral 101 denotes an LD, reference numeral 111 denotes a PD, reference numeral 10 denotes an LD drive circuit, reference numeral 11 denotes a phase compare circuit, reference numeral 12 denotes a filter circuit, and reference numeral 13 denotes a deterioration judgement circuit.

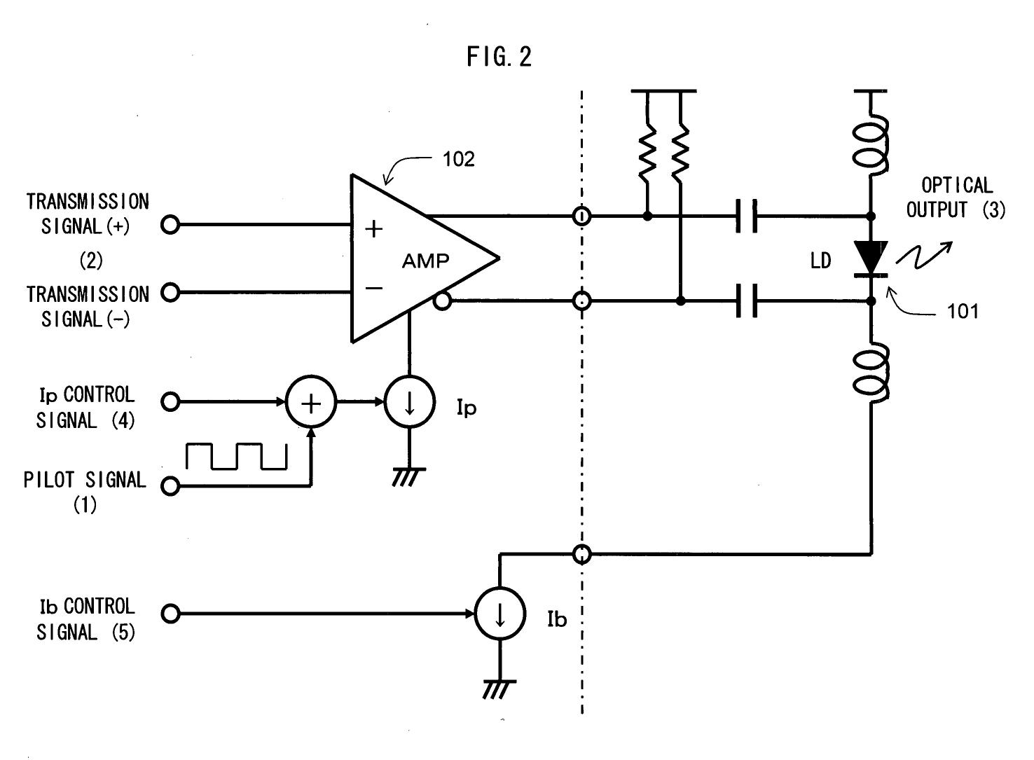

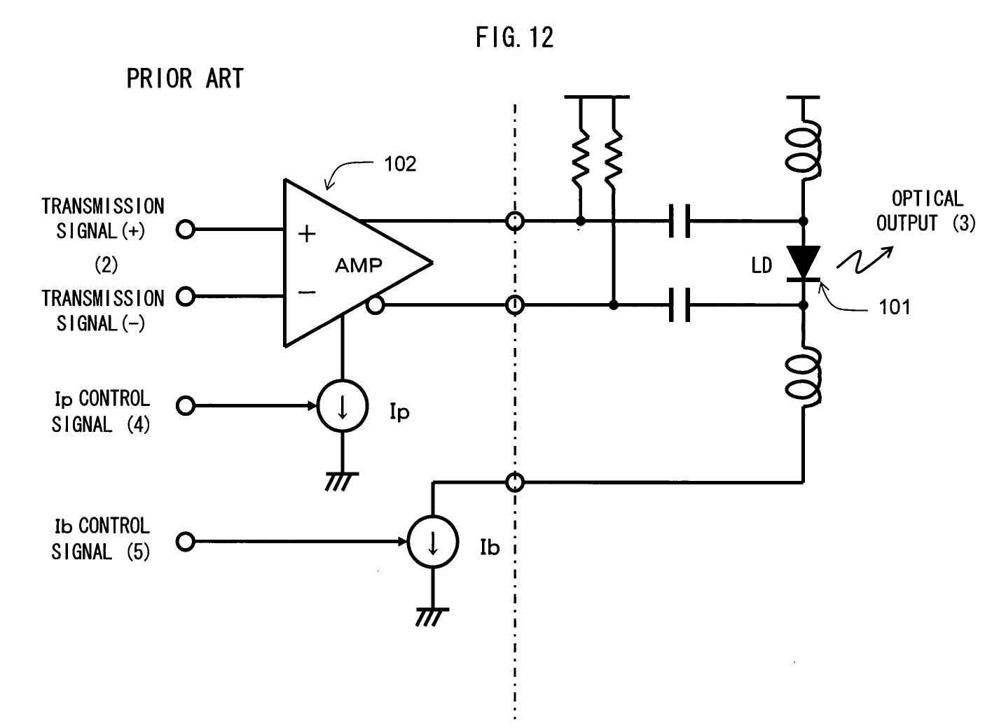

FIG. 2 is a diagram for explaining direct modulation of the LD 101 according to this embodiment. Compared with the configuration shown in FIG. 12, a pilot signal (1) is superimposed on a modulation current Ip. By superimposing the generated pilot signal (1) on an Ip control signal (4), a transmission signal (2) is modulated in accordance with the modulation current Ip on which the pilot signal (1) is superimposed, and is applied to the LD 101 biased in accordance with a bias current Ib controlled based on the Ib control signal (5).

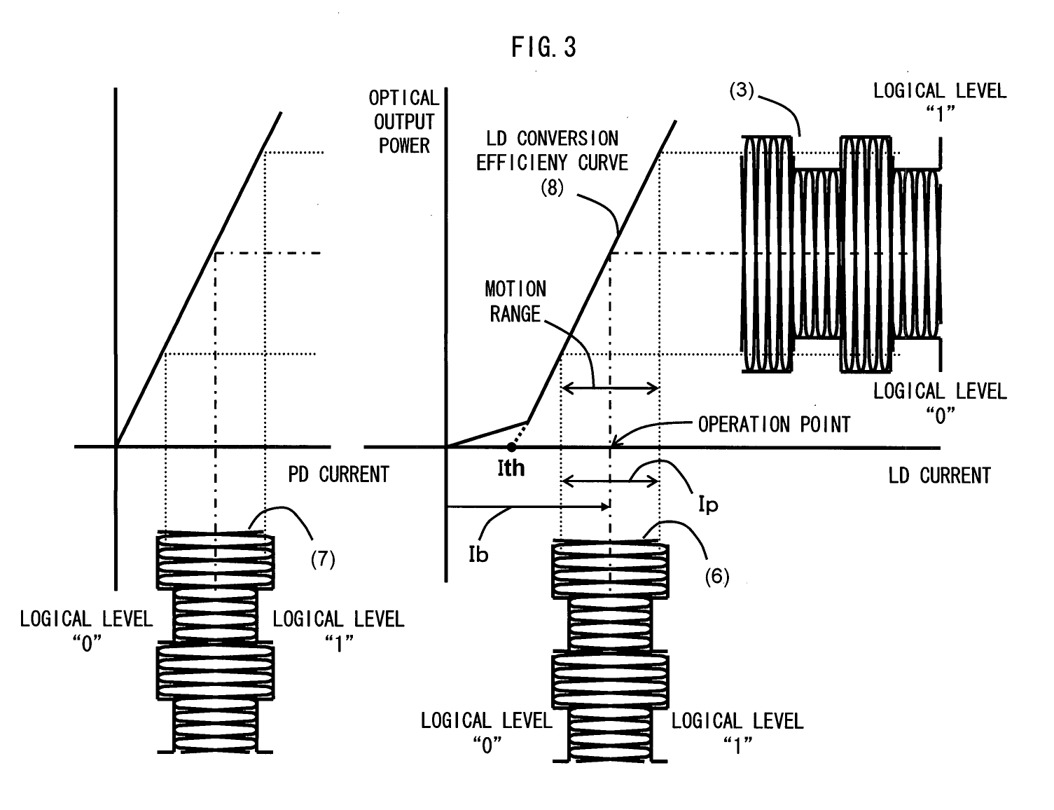

FIG. 3 is a diagram for explaining an example of the operation of the optical transmitter according to the embodiment. An LD current (6) for driving the LD 101, an LD conversion efficiency curve (8), an LD optical output (3), and a PD current (7) are shown in FIG. 3.

The pilot signal (1) has a frequency sufficiently lower than that of the transmission signal (2). For example, when the transmission signal (2) has a frequency of 2.4 GHz, the pilot signal (1) has a frequency of about 2 KHz. Although, in the first embodiment, the pilot signal (1) has a constant cycle of logical levels “1” and “0”, the pilot signal (1) may have a unique and specified pattern that allows an opposing optical receiver in a transmission system including the optical transmitter to recognize a transmission destination.

The generated pilot signal (1) is supplied to the LD drive circuit 10 and the phase compare circuit 11. As shown in FIG. 2, in the LD drive circuit 10, by superimposing the generated pilot signal (1) on the Ip control signal (4), the transmission signal (2) is modulated in accordance with the modulation current Ip on which the pilot signal (1) is superimposed. The LD current (6) is applied to the LD 101 biased in accordance with the bias current Ib controlled based on the Ib control signal (5).

The Ip control signal (4) controls an amplitude value of the LD current (6). An amplification rate of the AMP (102) increases, and the LD current (6) grows by enlarging the Ip control signal (4). The Ib control signal (5) controls a center value of the LD current (6). The center value grows by enlarging the Ib control signal (5).

So, a motion range of the LD current (6) is determined in accordance with the Ip control signal (4), an operation point is determined in accordance with the Ib control signal (5), as shown in FIG. 3.

Since FIG. 3 shows a case where the operation point and the motion range of the LD current (6) are set to the LD threshold current Ith or more, the LD optical output (3) is generated in accordance with the gradient of the LD conversion efficiency curve (8).

The PD 111 monitors part of the LD optical output (3), and outputs to the filter circuit 12 the PD current (7) obtained by photoelectric conversion.

The filter circuit 12 passes the PD current (7) in a frequency band equal to or lower than that of the pilot signal (1). Alternatively, the filter circuit 12 passes frequency components in the frequency band of the pilot signal (1). Since a pilot signal included in each of the LD optical output (3) and the PD current (7) that monitors the LD optical output (3) is superimposed on the modulation current Ip and modulated, the pilot signal has a positive phase on the side of logical level “1” and a negative phase on the side of logical level (0). Thus, when the LD optical output (3) is converted in accordance with the same gradient as the LD conversion efficiency curve (8), since the filter circuit 12 averages a pilot signal of a positive phase on the side of logical level “1” and a pilot signal of a negative phase on the side of logical level “0”, the filter circuit 12 does not output a pilot signal.

The phase compare circuit 11 judges whether or not the filter circuit 12 outputs a pilot signal. When the filter circuit 12 outputs a pilot signal, the phase compare circuit 11 judges whether or not the pilot signal output from the filter circuit 12 has a positive phase or a negative phase by comparing the phase of the pilot signal output from the filter circuit 12 with the generated pilot signal (1).

The deterioration judgement circuit 13 judges, in accordance with a comparison result of the phase compare circuit 11, that the LD 101 is in the normal state, that is, the LD 101 does not deteriorate when the filter circuit 12 does not output a pilot signal.

### Second Embodiment

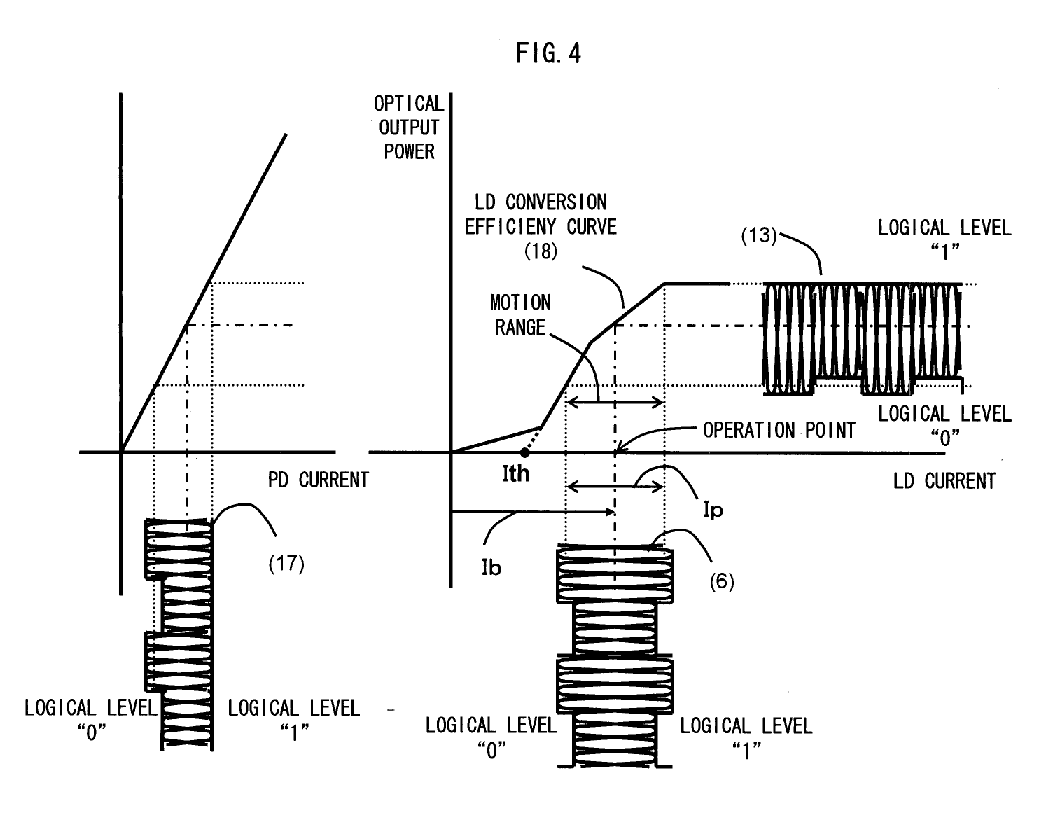

FIG. 4 is a diagram for explaining an example of the operation of the optical transmitter according to another embodiment of the present invention. Compared with the operation described with reference to FIG. 3, an operation of the optical transmitter when deterioration occurs in an LD conversion efficiency curve will be explained.

For an optical output (13) obtained by converting the LD current (6), a pilot signal of a positive phase on the side of logical level “1” is completely suppressed, in accordance with an LD conversion efficiency curve (18) when the LD 101 deteriorates. Similarly, for a PD current (17) that monitors the optical output (13), a pilot signal of a positive phase on the side of logical level “1” is completely suppressed.

Thus, the filter circuit 12 extracts only a pilot signal of a negative phase on the side of logical level “0”.

The phase compare circuit 11 compares the phase of the pilot signal of the negative phase on the side of logical level “0” with the phase of the generated pilot signal (1), and reports that the pilot signal of the negative phase is detected.

In accordance with the comparison result of the phase compare circuit 11, the deterioration judgement circuit 13 judges that the gradient of the LD conversion efficiency curve (18) is abnormal, and determines that the LD 101 deteriorates.

### Third Embodiment

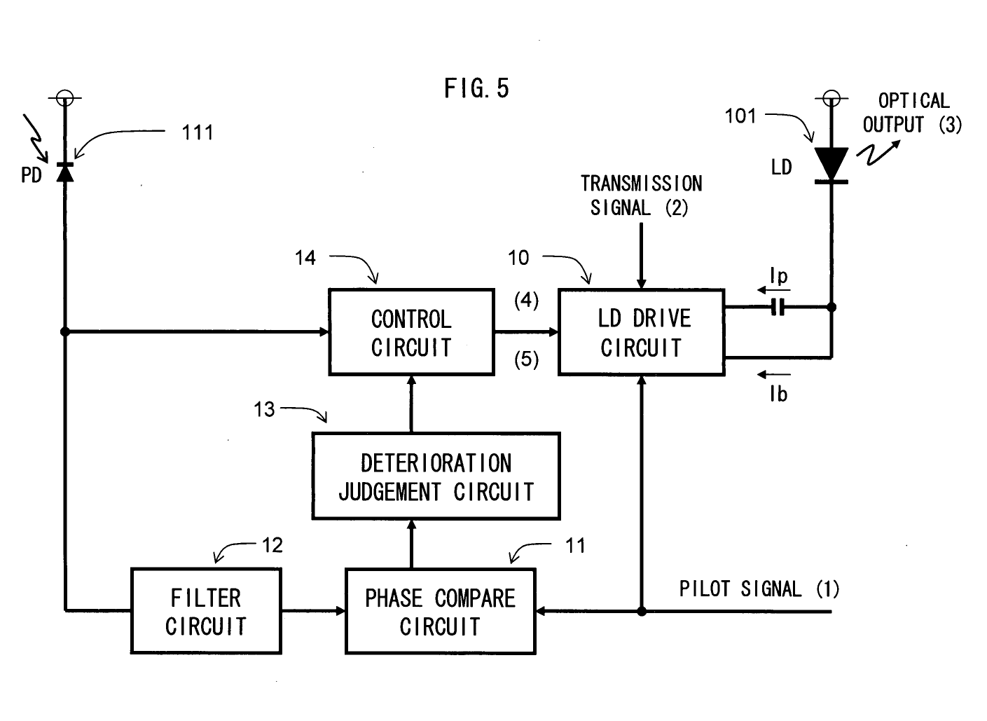

FIG. 5 is a diagram for explaining an example of the configuration of the optical transmitter according to another embodiment of the present invention. Compared with the configuration shown in FIG. 1, a control circuit 14 controls the LD drive circuit 10 in accordance with a deterioration judgement result of the deterioration judgement circuit 13 and a monitor signal of the PD 111.

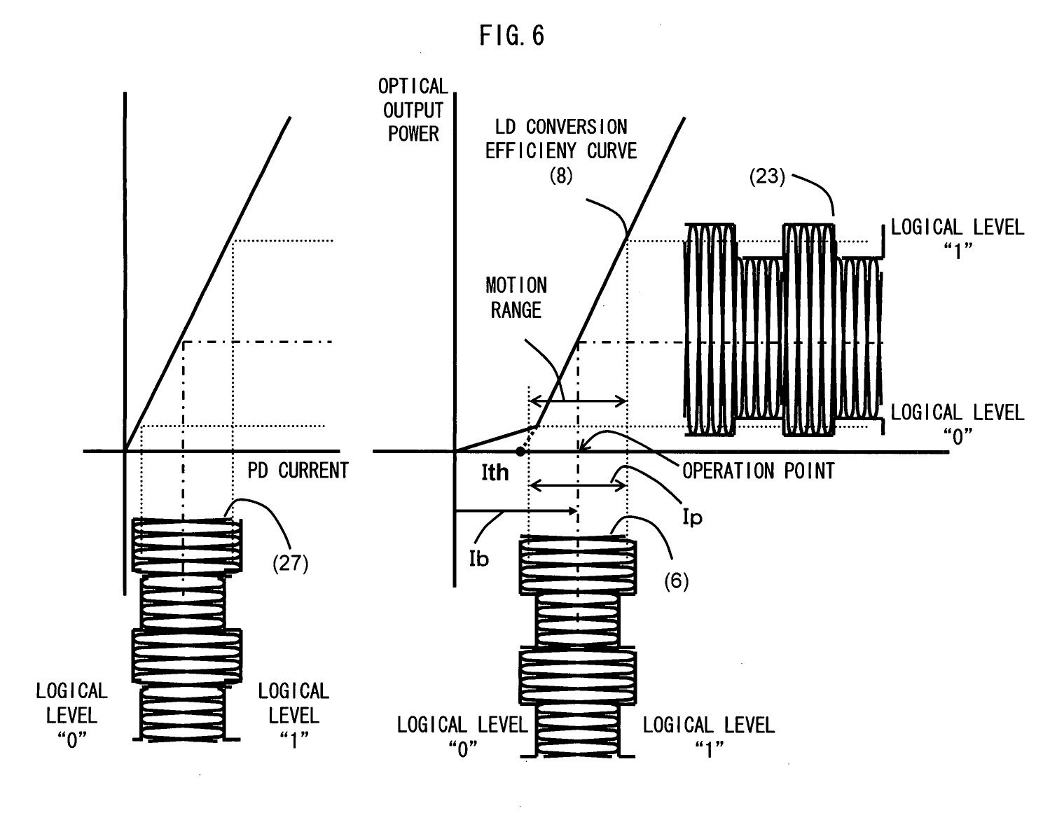

FIG. 6 is a diagram for explaining an example of the operation of the optical transmitter according to this embodiment. Compared with the operation described with reference to FIG. 3, although the same LD conversion efficiency curve (8) is acquired, the bias current Ib is smaller. Thus, the operation point and the motion range of the LD 101 are lower, and part of the motion range of the LD 101 is less than the LD threshold current Ith.

In the operation point and the motion range of the LD 101, for an optical output (23) obtained by converting the LD current (6), a pilot signal of a negative phase on the side of logical level “0” is suppressed, in accordance with the LD conversion efficiency curve (8). Similarly, for a PD current (27) that monitors the optical output (23), a pilot signal in which a negative phase on the side of logical level “0” is suppressed is acquired.

Since the filter circuit 12 averages a pilot signal of a positive phase on the side of logical level “1” and a pilot signal of a negative phase on the side of logical level “0”, the filter circuit 12 outputs a pilot signal of a positive phase on the side of logical level “1”.

The phase compare circuit 11 compares the phase of the pilot signal of the positive phase on the side of logical level “1” with the phase of the generated pilot signal (1), and reports to the deterioration judgement circuit 13 that the pilot signal of the positive phase is detected.

In accordance with the comparison result of the phase compare circuit 11, the deterioration judgement circuit 13 judges that the operation point and the motion range of the LD 101 are lower, and determines that the LD 101 does not deteriorate.

In accordance with the judgement result and the determination result of the deterioration judgement circuit 13, the control circuit 14 controls the LD drive circuit 10 using the Ib control signal (5) such that the bias current Ib increases in order to achieve a higher operation point.

### Fourth Embodiment

With the configuration of the optical transmitter shown in FIG. 5, when the LD conversion efficiency curve (18) shown in FIG. 4 is acquired, in accordance with judgement by the deterioration judgement circuit 13 that the LD 101 deteriorates, the control circuit 14 maintains control for the LD drive circuit 10 using the Ip control signal (4) and the Ib control signal (5). In addition, in a system using the optical transmitter, if allowable, the control circuit 14 may stop controlling the LD drive circuit 10 using the Ip control signal (4) and the Ib control signal (5).

### Fifth Embodiment

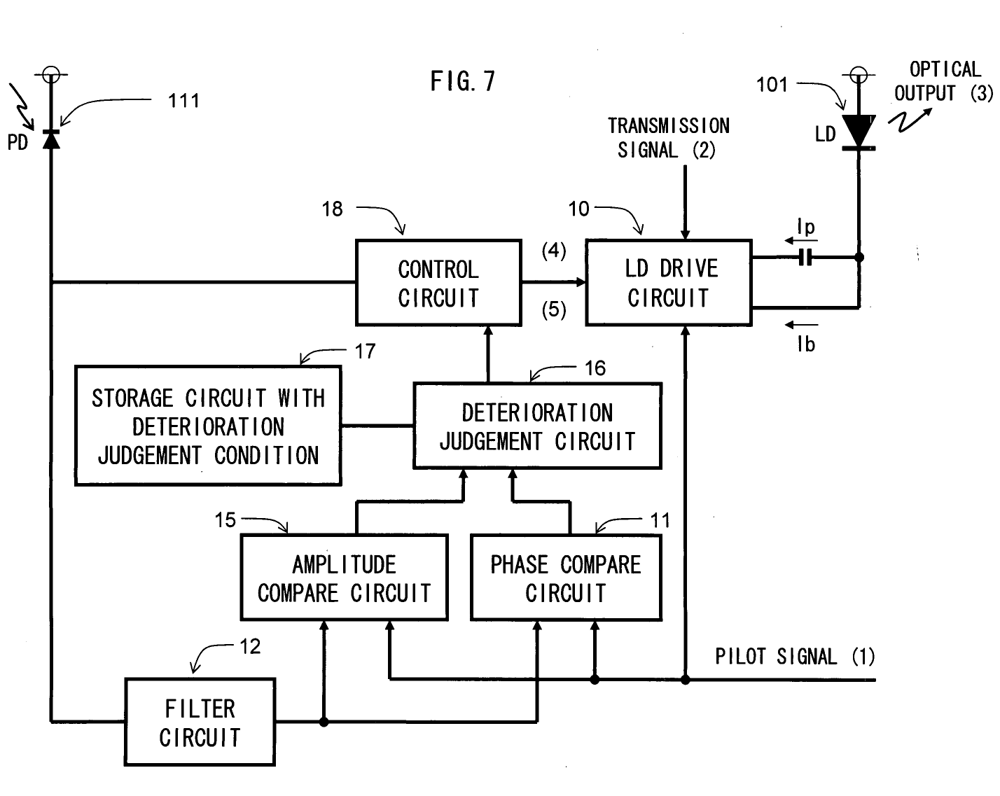

FIG. 7 is a diagram for explaining an example of the configuration of the optical transmitter according to another embodiment of the present invention. Compared with the configuration shown in FIG. 5, an amplitude compare circuit 15, a deterioration judgement circuit 16, a storage circuit 17 with deterioration judgement condition, and a control circuit 18 are provided.

The amplitude compare circuit 15 compares the amplitude value of the pilot signal (1) with the amplitude value of a pilot signal obtained in the filter circuit 12 by averaging a pilot signal of a positive phase on the side of logical level “1” and a pilot signal of a negative phase on the side of logical level “0”.

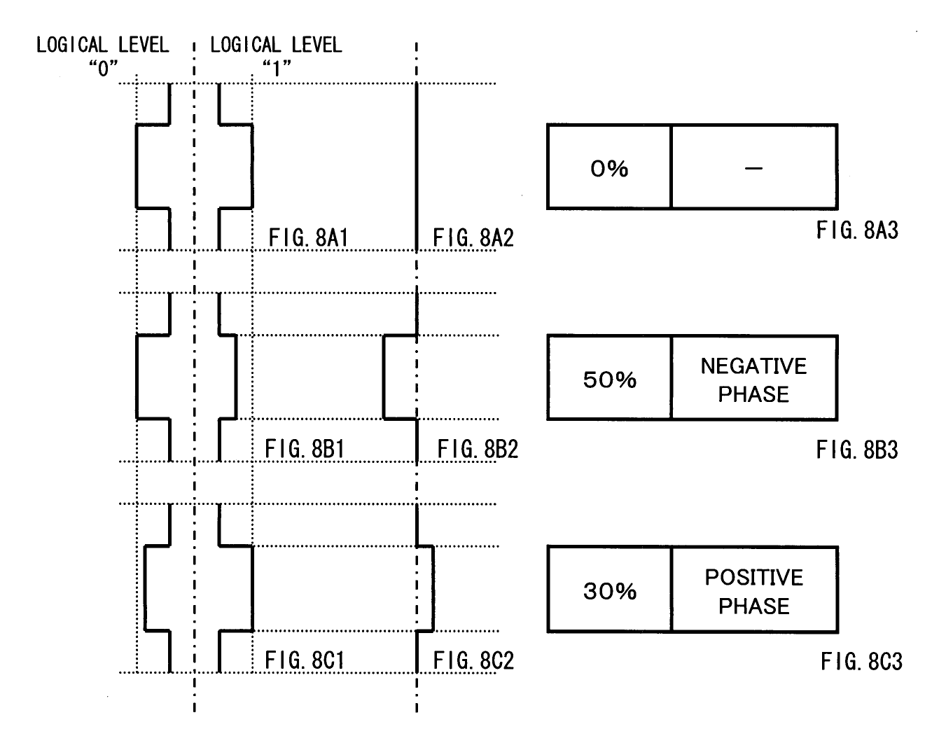

FIG. 8 includes diagrams for explaining the amplitude compare circuit. Each of FIGS. 8A1, 8B1, and 8C1 represents a PD current focused on a pilot signal obtained by monitoring an optical output of the PD 111. Each of FIGS. 8A2, 8B2, and 8C2 represents an output of the filter circuit 12, which is a pilot signal obtained by averaging a pilot signal of a positive phase on the side of logical level “1” and a pilot signal of a negative phase on the side of logical level “0”. Each of FIGS. 8A3, 8B3, and 8C3 represents a comparison result of the amplitude compare circuit 15, which includes a ratio of the filtered pilot signal shown in each of FIGS. 8A2, 8B2, and 8C2 to the pilot signal (1) and a phase of the filtered pilot signal. FIGS. 8A1, 8A2, and 8A3 show a case where the LD 101 does not deteriorate, as shown in FIG. 3. In this case, a comparison result of the amplitude compare circuit 15 is 0%. FIGS. 8B1, 8B2, and 8B3 show a case where the gradient of the LD conversion efficiency curve (18) is not 0 and a pilot signal of a positive phase on the side of logical level “1” is half suppressed, as shown in FIG. 4. In this case, a comparison result of the amplitude compare circuit 15 is 50%, and a negative phase is detected. FIGS. 8C1, 8C2, and 8C3 show a case where although the LD 101 does not deteriorate, the operation point and the motion range of the LD 101 are lower since the bias current Ib is small, and part of the motion range of the LD 101 is less than the LD threshold current Ith, as shown in FIG. 6. Thus, a pilot signal of a negative phase on the side of logical level “0” is suppressed by only 30%. In this case, a comparison result of the amplitude compare circuit 15 is 30%, and a positive phase is detected.

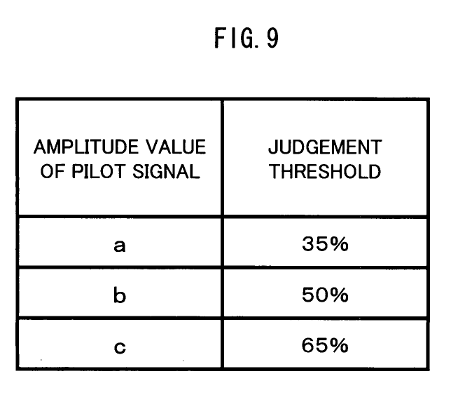

FIG. 9 is a diagram for explaining a deterioration judgement condition. The deterioration judgement condition shown in FIG. 9 is a condition used by the deterioration judgement circuit 16 to judge deterioration of the LD 101 and is stored in the storage circuit 17. An amplitude value of a pilot signal represents an amplitude value of the pilot signal (1), and a judgement threshold represents a threshold for judging that the degree of deterioration is normal with respect to comparison results of the amplitude compare circuit 15 shown in FIGS. 8A3, 8B3, and 8C3.

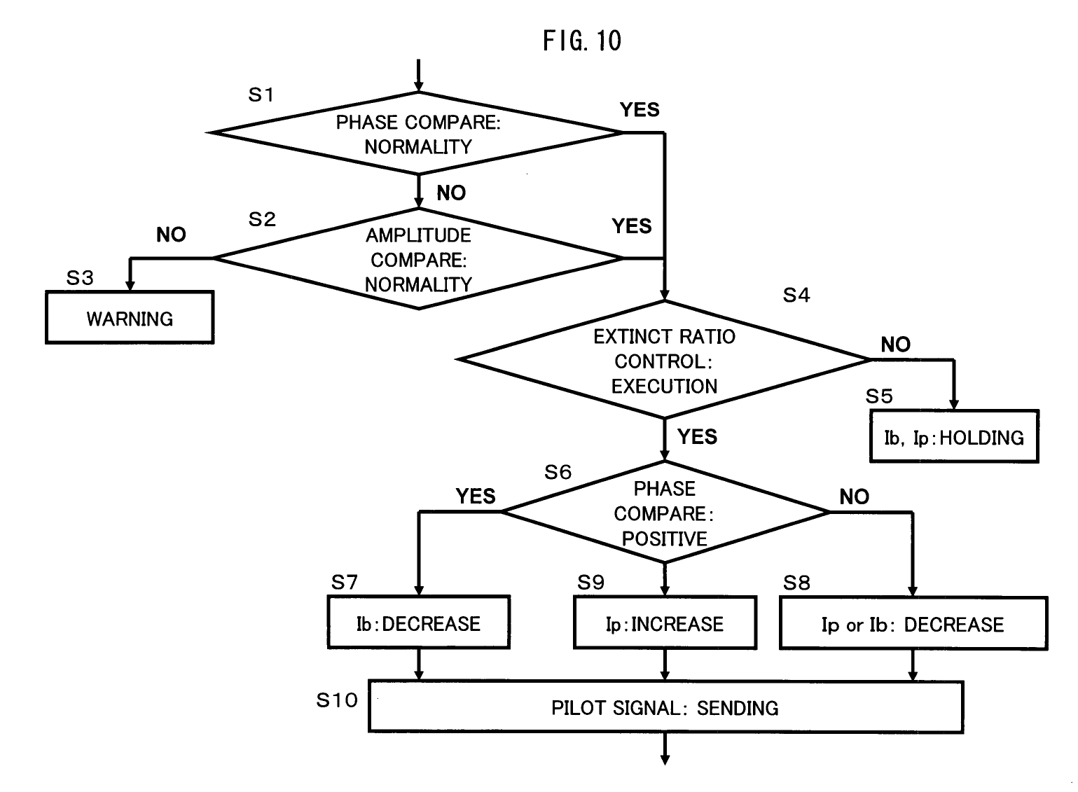

FIG. 10 is a flowchart of a deterioration judgement and extinct ratio control process. The process for judging deterioration of an LD and for controlling an extinct ratio using a phase comparison result, an amplitude comparison result, and a deterioration judgement condition is described next.

In step S1, a result of phase comparison performed by the phase compare circuit 11 between the phase of the pilot signal (1) and the phase of the pilot signal filtered by the filter circuit 12 is judged. If a pilot signal does not appear in the filtered pilot signal, that is, if a pilot signal of a positive phase on the side of logical level “1” and a pilot signal of a negative phase on the side of logical level “0” are averaged and a pilot signal is not output, it is judged that it is in the normal state. For other cases, that is, if a pilot signal of a positive or negative phase appears in the filtered pilot signal, it is judged that it is not in the normal state.

In step S2, if it is judged in step S1 that it is not in the normal state, a result of amplitude comparison performed by the amplitude compare circuit 15 between the amplitude value of the pilot signal (1) and the amplitude value of the pilot signal filtered by the filter circuit 12 is judged. In accordance with the deterioration judgement condition shown in FIG. 9, the ratio of the amplitude value of the filtered pilot signal to the amplitude value of the pilot signal (1) is acquired. It is judged whether or not the acquired ratio is within a normal range with respect to a judgement threshold corresponding to the amplitude value of the pilot signal (1).

In step S3, if the amplitude ratio is not within the normal range in step S2, it is determined that the LD 101 deteriorates and a warning is issued. The control circuit 18 may maintain control for optical output power of the LD 101 and the extinct ratio of the optical output of the LD 101. In addition, the control circuit 18 may control the optical output of the LD 101 to stop.

In step S4, if the result of phase comparison is normal in step S1 or if the result of amplitude comparison is normal in step S2, it is judged whether or not to control the extinct ratio of the optical output of the LD 101. If the present extinct ratio satisfies the characteristic of the optical transmission system including the optical transmitter to be controlled, it is judged that the extinct ratio is not to be controlled. If the extinct ratio is to be improved, it is judged that the extinct ratio is to be controlled.

In step S5, if it is judged in step S4 that the extinct ratio is not to be improved, the control circuit 18 controls the bias current Ib and the modulation current Ip to hold the present values.

In step S6, if it is judged in step S4 that the extinct ratio is to be improved, it is judged whether the result of phase comparison performed by the phase compare circuit 11 between the phase of the pilot signal (1) and the phase of the pilot signal filtered by the filter circuit 12 is a positive phase, a negative phase, or non-appearance of a pilot signal in the filtered pilot signal.

In step S7, if the result of phase comparison in step S6 is a positive phase, the control circuit 18 decreases the modulation current Ip. By decreasing the modulation current Ip, an operation of the pilot signal of the negative phase on the side of logical level “0” at the LD threshold current Ith or less is improved. The amount of change in the modulation current Ip is determined in accordance with control information stored in a control table (not shown) provided in advance in the control circuit 18.

In step S8, if the result of phase comparison in step S6 is a negative phase, the control circuit 18 decreases the bias current Ib or the modulation current Ip. By decreasing the bias current Ib, an operation point in an LD conversion efficiency curve is moved to a smaller LD current side, and an operation at a curve point in the LD conversion efficiency curve of a pilot signal of a positive phase on the side of logical level “1” whose gradient is smaller than the gradient of the LD conversion efficiency curve of a pilot signal of a negative phase on the side of logical level “0” is improved. The amount of decrease in the modulation current Ip or the bias current Ib is determined in accordance with control information stored in a control table (not shown) provided in advance in the control circuit 18.

In step S9, if the result of phase comparison in step S6 is that a pilot signal does not appear in the filtered pilot signal, the control circuit 18 increases the modulation current Ip. By increasing the modulation current Ip, the motion range in the LD conversion efficiency curve is increased, and the extinct ratio is increased.

In step S10, after the processing in step S7, S8, or S9 is performed, the pilot signal (1) is transmitted to judge whether or not the extinct ratio is improved by the processing. The processing in step S10 must be performed when an optical transmitter that appropriately outputs the pilot signal (1) is used. If an optical transmitter that always outputs the pilot signal (1) is used, the processing in step S10 can be omitted. By transmitting the pilot signal (1), the processing from step S1 is performed, and an extinct ratio that satisfies the characteristic of the optical transmission system can be achieved.

### Sixth Embodiment

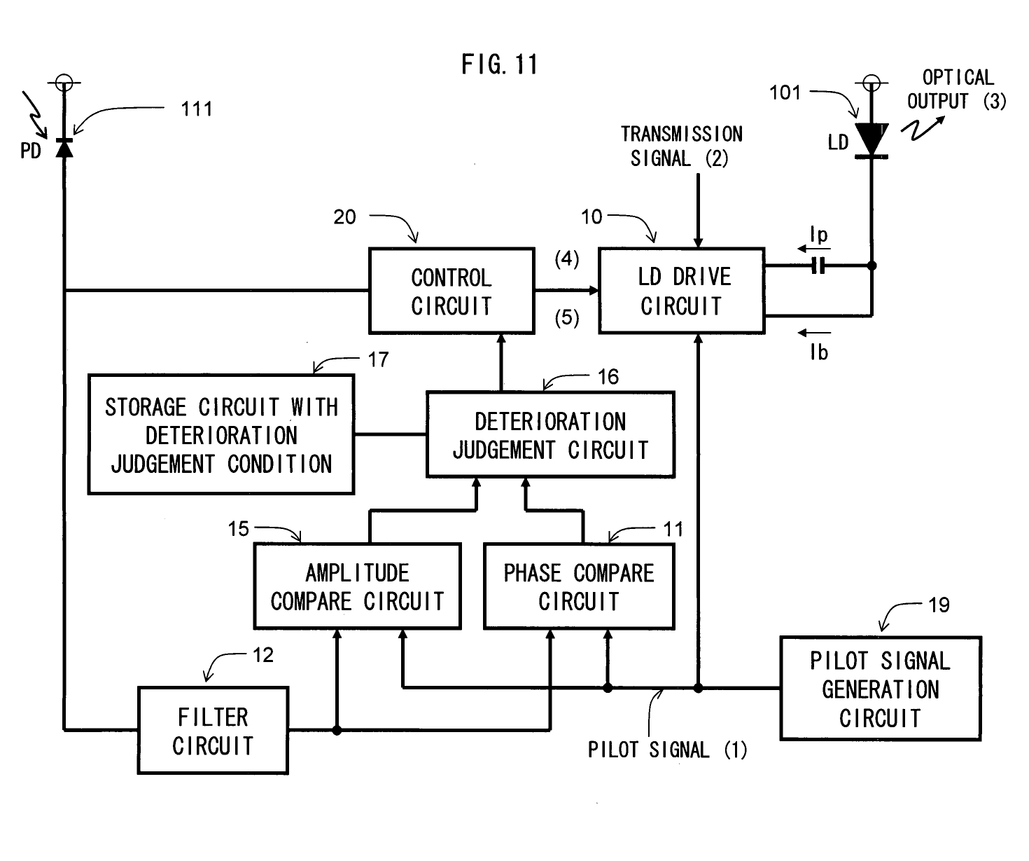

FIG. 11 is a diagram for explaining an example of the configuration of the optical transmitter according to another embodiment of the present invention. Compared with the configuration shown in FIG. 7, a pilot signal generation circuit 19 is provided. The pilot signal generation circuit 19 generates a pilot signal whose pattern, generation cycle, generation timing, and amplitude value are controlled by a control circuit 20.

What is claimed is:

1. An optical transmitter comprising:
a laser diode drive circuit for driving a laser diode in accordance with a laser diode current that superimposes a pilot signal on a “0” logic level and a “1” logic level of a transmission signal, the pilot signal having a low-frequency compared with the transmission signal, so as to become an opposite phase each other;
a monitor circuit for monitoring an optical output of the laser diode;
a filter circuit for extracting a low-frequency component of the pilot signal from an output of the monitor circuit;
a phase compare circuit for comparing a phase of the low-frequency component of the pilot signal extracted by the filter circuit with a phase of the pilot signal; and
a deterioration judgment circuit for judging whether or not the laser diode deteriorates in accordance with a comparison result of the phase compare circuit.

2. The optical transmitter according to claim 1, further comprising:
a control circuit for controlling one of or both of optical output power of the laser diode and an extinct ratio of the optical output of the laser diode in accordance with a monitor current output by the monitor circuit,
wherein the control circuit maintains control for optical output power of the laser diode and the extinct ratio of the optical output of the laser diode when the deterioration judgment circuit judges the laser diode deteriorating.

3. The optical transmitter according to claim 2, further comprising:
an amplitude compare circuit for comparing an amplitude value of the low-frequency component of the pilot signal extracted by the filter circuit with an amplitude value of the pilot signal,
wherein the deterioration judgment circuit judges a state of deterioration of the laser diode in accordance with the comparison result of the phase compare circuit, a comparison result of the amplitude compare circuit, and deterioration judgment condition of the laser diode registered beforehand,
wherein the control circuit controls the extinct ratio of the optical output of the laser diode in accordance with a judgment result of the deterioration judgment circuit.

4. The optical transmitter according to claim 3,
wherein the laser diode deterioration judgment condition includes a laser diode identification number for identifying a group categorized by a characteristic of the laser diode, an amplitude value of a pilot signal for representing the amplitude value of the generated pilot signal, and a judgment threshold value for judging whether or not the laser diode deteriorates on the basis of the amplitude value of the generated pilot signal for each laser diode individual identification number, and the laser diode deterioration judgment condition is registered in advance.

5. The optical transmitter according to claim 1,
wherein the filter circuit is one of a low-pass filter and band-pass filter.

6. The optical transmitter according to claim 2, further comprising:
a pilot signal generation circuit for generating a pilot signal of a specific pattern.

7. A method for controlling an optical transmitter comprising the steps of:
driving a laser diode in accordance with a laser diode current that superimposes a bias current on a modulation current for modulating a transmission signal on which superimposes a pilot signal;
monitoring an optical output of the laser diode;
extracting a low-frequency component of a pilot signal from an output of the monitor circuit;
comparing a phase of the low-frequency component of the pilot signal extracted by the filter circuit with a phase of the pilot signal;
judging whether or not the laser diode deteriorates in accordance with a comparison result of the phase compare circuit;
controlling one of or both of optical output power of the laser diode and an extinct ratio of the optical output of the laser diode in accordance with a monitor current outputting by the monitor circuit; and
maintaining control for optical output power of the laser diode and the extinct ratio of the optical output of the laser diode when it is judged that the laser diode deteriorates.

8. The method for controlling an optical transmitter according to claim 7, further comprising the steps of:
comparing an amplitude value of the low-frequency component of the pilot signal extracted by the filter circuit with an amplitude value of the pilot signal;
judging a state of deterioration of the laser diode in accordance with the comparison result of the phase compare circuit, a comparison result of the amplitude compare circuit, and deterioration judgment condition of the laser diode registered beforehand;
controlling the extinct ratio of the optical output of the laser diode in accordance with a judgment result of the deterioration of the laser diode.

9. The method for controlling an optical transmitter according to claim 8,
wherein when the result of the phase comparison is within a normal range, when the result of the amplitude comparison is within a normal range, and when the extinct ratio is to be controlled,
the modulation current is decreased when the result of the phase comparison is a positive phase,
one of the bias current and the modulation current is decreased when the result of the phase comparison is a negative phase,
the modulation current is increased when the result of the phase comparison is not one of the positive phase and the negative phase.
